(19) United States
(12) Patent Application Publication
(10) Pub. No.: US 2006/0262329 A1
(43) Pub. Date: Nov. 23, 2006

(54) Image processing device, image processing method and program product for the same

(75) Inventor: Yukimitsu Fujimori, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/316,710

(22) Filed: Dec. 27, 2005

(30) Foreign Application Priority Data
Dec. 28, 2004 (JP) 2004-379087

(51) Int. Cl. G06K 15/02

(52) U.S. Cl. 358/1.2

(57) ABSTRACT

An image processing device of the invention converts a resolution of input image data into a preset recording resolution and generates print data. In the image processing device of the invention, multiple halftoning process modules are provided corresponding to multiple different aspect ratios of recording resolutions as resolutions for image recording to respectively perform different halftoning processes according to the different aspect ratios. The image processing device sets one recording resolution among multiple recording resolutions, which include at least two different recording resolutions having an identical aspect ratio, and converts the resolution of the input image data according to the set recording resolution to generate multi-tone data representing tone values expressed in respective pixels of the image data. The image processing device selectively activates one of the multiple halftoning process modules corresponding to an identified aspect ratio of the set recording resolution to perform the corresponding halftoning process and convert the multi-tone data into dot state data, and outputs the dot state data in a predetermined order as the print data. This arrangement desirably reduces the total required memory capacity.

### CLAIM OF PRIORITY

The present application claims the priority from Japanese application P2004-379087A filed on Dec. 28, 2004, the contents of which are hereby incorporated by reference into this application.

### BACKGROUND OF THE INVENTION

1. Field of the Invention

The present invention relates to an image processing device that executes a halftoning process and converts input image data into print data.

2. Description of the Related Art

As is known in the art, the image processing typically adopts one of various quasi-halftone expression techniques, for example, a dither method or a halftone dot processing method (see, for example, JP-A-H11-355571 and JP-A-2002-77646). The quasi-halftone expression technique called the halftoning process compares multi-tone image data with preset threshold values and generates 2-tone dot state data representing the dot-on state or the dot-off state in individual pixels. An image processing device, such as a computer or a printer, executes the halftoning process and converts input image data into print data to generate a resulting printed image. The image processing device stores in advance the preset threshold values required for the halftoning process to specify the dot on-off state in the respective pixels. For example, the above cited references respectively disclose the technique of reducing the memory capacity for storing threshold values used for the dither method and the technique of setting threshold values for the halftone dot processing to reduce the total memory capacity.

These prior art image processing devices are designed to process different input tone values but do not take into account different output resolutions (resolutions for printing available in a printing device, hereafter referred to as recording resolutions). The printing device may be capable of printing images at multiple different recording resolutions, for example, 600×600 dpi and 300×300 dpi. In this case, halftoning process modules including multiple different sets of threshold values are required corresponding to the multiple different recording resolutions. Namely multiple different halftoning process modules are to be provided corresponding to the multiple different recording resolutions. Such requirement undesirably increases the total memory capacity, the number of required parts, and the manufacturing cost.

Such requirement also increases the number of process steps in a design flow. The dither method and the error diffusion method, which are known techniques typically adopted for the halftoning process, require design and tuning of halftoning process modules corresponding to the respective recording resolutions to ensure the appropriate dispersibility of dots. The increased number of the recording resolutions available in the printing device undesirably increases the number of process steps in the design flow.

### SUMMARY OF THE INVENTION

The object of the invention is thus to eliminate the drawbacks of the prior art techniques and to reduce the total required memory capacity in an image processing device.

In order to attain at least part of the above and the other related objects, an aspect of the present invention is directed to an image processing device that converts a resolution of input image data into a preset recording resolution and generates print data. The image processing device includes: multiple halftoning process modules that are provided corresponding to multiple different aspect ratios of recording resolutions as resolutions for image recording and respectively perform different halftoning processes according to the different aspect ratios; a recording resolution setting module that sets one recording resolution among multiple recording resolutions, which include at least two different recording resolutions having an identical aspect ratio; a multi-tone data generation module that converts the resolution of the input image data according to the set recording resolution and generates multi-tone data representing tone values expressed in respective pixels of the image data; a processing execution module that selectively activates one of the multiple halftoning process modules corresponding to an identified aspect ratio of the set recording resolution to perform the corresponding halftoning process and convert the multi-tone data into dot state data; and a data output module that outputs the dot state data in a predetermined order as the print data.

There is an image processing method corresponding to the image processing device described above. An aspect of the present invention is thus directed to an image processing method that converts a resolution of input image data into a preset recording resolution and generates print data. The image processing method includes the steps of: providing multiple halftoning process modules corresponding to multiple different aspect ratios of recording resolutions as resolutions for image recording to respectively perform different halftoning processes according to the different aspect ratios; setting one recording resolution among multiple recording resolutions, which include at least two different recording resolutions having an identical aspect ratio; converting the resolution of the input image data according to the set recording resolution and generating multi-tone data representing tone values expressed in respective pixels of the image data; selectively activating one of the multiple halftoning process modules corresponding to an identified aspect ratio of the set recording resolution to perform the corresponding halftoning process and convert the multi-tone data into dot state data; and outputting the dot state data in a predetermined order as the print data.

The image processing device and the corresponding image processing method provide multiple halftoning process modules corresponding to multiple different aspect ratios of the recording resolutions to perform different halftoning processes. One of the multiple halftoning process modules is activated corresponding to the identified aspect ratio of the set recording resolution to perform the corresponding halftoning process. The halftoning process modules are provided not corresponding to all the available recording resolutions but corresponding to the aspect ratios of the recording resolutions. One identical processing module is applicable to plural recording resolutions having an identical aspect ratio. This arrangement of the invention desirably reduces the total memory capacity required for storing the multiple halftoning process modules in the image processing device or the image processing method that is capable of generating print data at multiple different recording resolutions.

In one preferable embodiment of the image processing device of the invention, at least one of the multiple halftoning process modules has a threshold value matrix, which defines plural threshold values used for determination of a dot on-off state in each pixel, and adopts a dither method with the threshold value matrix for the halftoning process.

The image processing device of this embodiment does not require storage of threshold value matrixes used for the dither method corresponding to all the available recording resolutions. The arrangement of this embodiment thus desirably reduces the total memory capacity for storing the threshold value matrixes. This is especially effective when each threshold value matrix used for the halftoning process by the dither method occupies a relatively large storage capacity.

In another preferable embodiment of the image processing device of the invention, at least one of the multiple halftoning process modules has an error diffusion matrix, which defines error diffusion rates to distribute a density error arising in each pixel by determination of a dot on-off state in the pixel to peripheral pixels in a neighborhood of the pixel, and adopts an error diffusion method with the error diffusion matrix for the halftoning process.

The image processing device of this embodiment does not require storage of error diffusion matrixes used for the error diffusion method corresponding to all the available recording resolutions. The arrangement of this embodiment thus desirably reduces the total memory capacity for storing the error diffusion matrixes. The error diffusion method may change over the applied error diffusion matrix according to the tone values of the input image data. The arrangement of this embodiment is especially effective in such applications to reduce the total memory capacity for storing the error diffusion matrixes.

In still another preferable embodiment of the image processing device of the invention, at least one of the multiple halftoning process modules has multiple dot patterns for dot creation and selectively uses one of the multiple dot patterns for the halftoning process according to a density of each pixel in the image data.

In the image processing device of this embodiment, the recording resolution set by the recording resolution setting module may have an aspect ratio out of three aspect ratios 2 to 1, 1 to 1, and 1 to 2 and may be selectable between the at least two different recording resolutions having an identical aspect ratio.

The generally used recording resolutions have aspect ratios of 2 to 1, 1 to 1, and 1 to 2. Providing three halftoning process modules corresponding to these three aspect ratios enables the processing of the input image data at any of the generally used recording resolutions.

The technique of the invention may also be actualized by a computer program executed to attain the image processing method described above or a recording medium in which such a computer program is recorded. Typical examples of the recording medium include flexible disks, CD-ROMs, DVD-ROMs, magneto-optical disks, memory cards, hard disks, and diversity of other computer readable media.

### BRIEF DESCRIPTION OF THE DRAWINGS

FIG. 1 is a block diagram illustrating the schematic structure of a printer as an image processing device embodying the invention;

FIG. 2 is a functional block diagram showing the functional structure of the printer of FIG. 1;

FIG. 3 shows recording resolutions corresponding to combinations of print mode and printing paper;

FIG. 4 conceptually shows dot creation at various recording resolutions;

FIG. 5 is a flowchart showing a halftoning process of a first embodiment;

FIG. 6 is a flowchart showing a halftoning process of a second embodiment;

FIG. 7 shows selection of settings for the halftoning process corresponding to each recording resolution;

FIGS. 8A and 8B show a design flow of the halftoning process in the invention and a conventional design flow of the halftoning process; and

FIG. 9 is a flowchart showing a modified flow of halftoning process to select one of multiple halftoning process modules corresponding to the aspect ratio of a preset recording resolution.

### DESCRIPTION OF THE PREFERRED EMBODIMENTS

Some modes of carrying out the invention are described below as preferred embodiments in the following sequence with reference to the accompanied drawings:

A. Structure of Printer

B. Halftoning Process of First Embodiment (Dither Method)

C. Halftoning Process of Second Embodiment (Error Diffusion Method)

D. Modifications

A. Structure of Printer

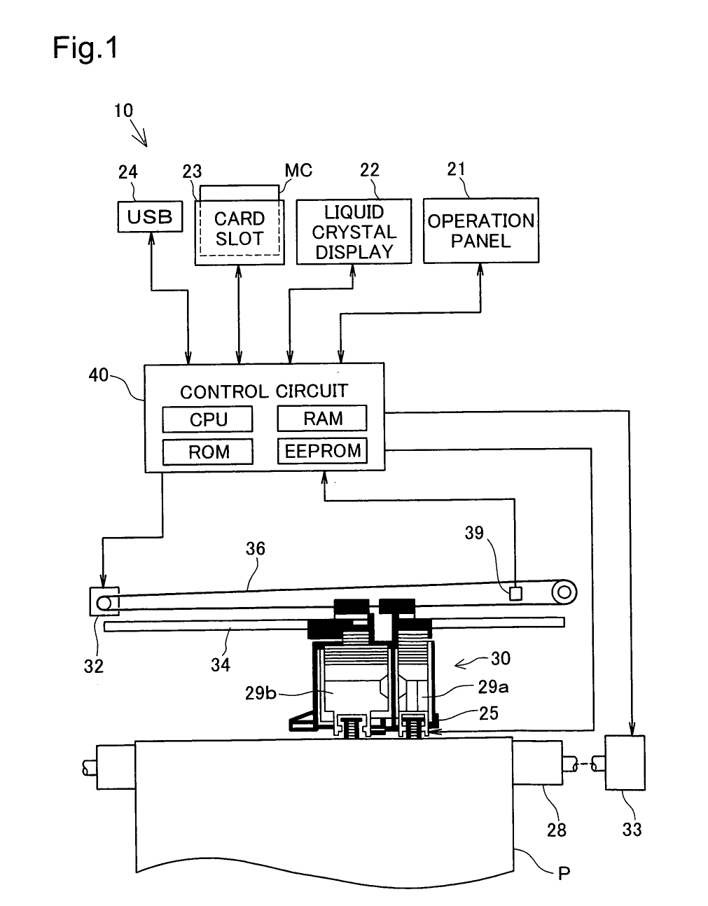

FIG. 1 is a block diagram illustrating the schematic structure of a printer 10 as an image processing device embodying the invention. The printer 10 of the embodiment is an inkjet printer that is capable of printing color images with four color inks, C (cyan), M (magenta), Y (yellow), and K (black). The printer 10 is equipped with a card slot 23 to receive a memory card MC that is inserted therein and stores images taken with, for example, a digital still camera. The printer 10 has a printer driver installed therein to convert each RGB color image read from the inserted memory card MC into print data representing the dot on-off state of the respective color dots.

As illustrated, the printer 10 has a carriage 30 that is equipped with a print head unit 25 for ejecting inks on printing paper P, a carriage motor 32 that drives the carriage 30 in a main scanning direction, a paper feed motor 33 that feeds the printing paper P, and a control circuit 40 that includes a CPU, a ROM, a RAM, and an EEPROM and controls the operations of the print head unit 25, the carriage motor 32, and the paper feed motor 33.

The print head unit 25 has four ink ejection heads for the four color inks, C, M, Y, and K. A black ink cartridge 29a and a color ink cartridge 29b are attached to the carriage 30. Regulation of the voltages of piezoelectric elements (not shown) ejects the inks from the respective ink cartridges 29a and 29b onto the printing paper P.

The carriage motor 32 rotates a drive belt 36 to move back and forth the carriage 30 along a sliding shaft 34, which is arranged in parallel with the axis of a platen 28. The position of the origin of the reciprocating carriage 30 is detected by a position detection sensor 39 and is output to the control circuit 40.

The paper feed motor 33 rotates the platen 28 to feed the printing paper P set in the printer 10 and accordingly contributes to creation of dots in a sub-scanning direction that is perpendicular to the main scanning direction of the carriage 30. The printing paper P is fed by a predetermined amount corresponding to the rotational angle of the platen 28.

The control circuit 40 stores the printer driver and various programs relating to the operations of the printer 10 in its internal ROM. The printer driver is activated in response to each requirement to generate print data from input image data. The control circuit 40 controls the respective actuators according to the generated print data. For example, the control circuit 40 outputs voltage signals corresponding to the generated print data to piezoelectric elements on the print head unit 25, while outputting preset electric signals representing the position of the carriage 30 and the paper feed amount specified by the generated print data to the carriage motor 32 and the paper feed motor 33.

The control circuit 40 also functions as an external interface and is electrically connected with an operation panel 21, a liquid crystal display 22, and an USB port 24, as well as with the card slot 23.

The operation panel 21 has multiple operation buttons (not shown) and is manipulated by the user to select a desired image as an object of printing and to set a desired print mode. The liquid crystal display 22 is a color display unit to display, for example, the user's settings of printing conditions, images recorded in the memory card MC, and possible options of the print mode.

The USB port 24 is connectable with an external device, for example, a computer or a hard disk. The printer 10 of the embodiment may be connected with a computer as an external device via the USB port 24 to entrust a required series of image processing to the computer. In this application, the computer with the printer driver is equivalent to the image processing device of the invention.

The card slot 23 is compatible with multiple different storage media, for example, SD memory cards (registered trademark), compact flash (registered trademark), and smart media (registered trademark).

In the printer 10 having the hardware configuration described above, the control circuit 40 outputs commands based on print data generated by the printer driver to actuate the carriage motor 32 and move the carriage 30 in the main scanning direction and to actuate the paper feed motor 33 and feed the printing paper P in the sub-scanning direction. The control circuit 40 repeats such main scans and sub-scans to eject ink droplets at adequate timings. The printer 10 accordingly creates small dots to complete a color printed image on the printing paper P.

The printer 10 of this embodiment uses the four color inks C, M, Y, and K for printing, but may be replaced by a printer using seven color inks for printing, LC (light cyan), LM (light magenta), and DY (dark yellow), in addition to CMYK.

The printer 10 of the embodiment is an inkjet printer utilizing piezoelectric elements for ink ejection. The technique of the invention is also applicable to various types of printers, for example, other inkjet printers including bubble jet printers (registered trademark), thermal transfer printers, dye sublimation printers, laser printers, and complex machines.

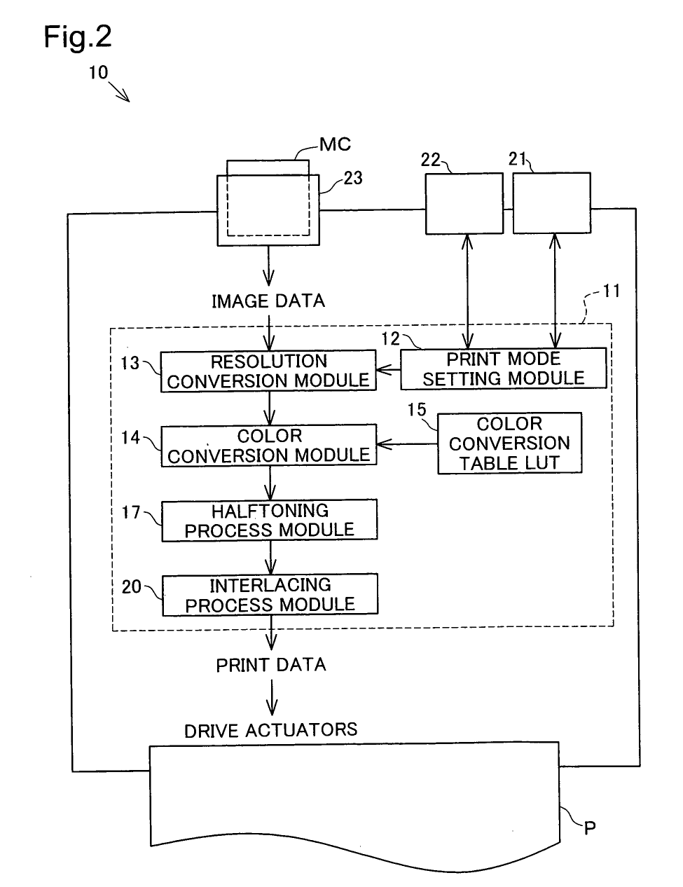

The description regards a print data generation process executed by the printer driver installed in the printer 10. FIG. 2 is a functional block diagram showing the functional structure of the printer 10 of the embodiment. As illustrated in FIG. 2, the printer 10 has multiple processing modules, a print mode setting module 12, a resolution conversion module 13, a color conversion module 14, a halftoning process module 17, and an interlacing process module 20. These processing modules are collectively called a printer driver 11. The halftoning process module 17 executes the halftoning process according to the identified aspect ratio of a preset recording resolution as described later in detail.

In response to the user's selection of a desired image as an object of printing among the images recorded in the memory card MC, the print mode setting module 12 shows possible options of the print mode on the liquid crystal display 22. The printer 10 of this embodiment provides three different print modes, ‘fast’, ‘fine’, and ‘high-definition’ and three different printing papers ‘plain paper’, ‘fine paper’, and ‘photo paper’ as possible options. The user manipulates the operation panel 21 to select desired options for the print mode and for the printing paper. The print mode setting module 12 sets one recording resolution for printing by the printer 10, based on the user's selection of the print mode and the printing paper.

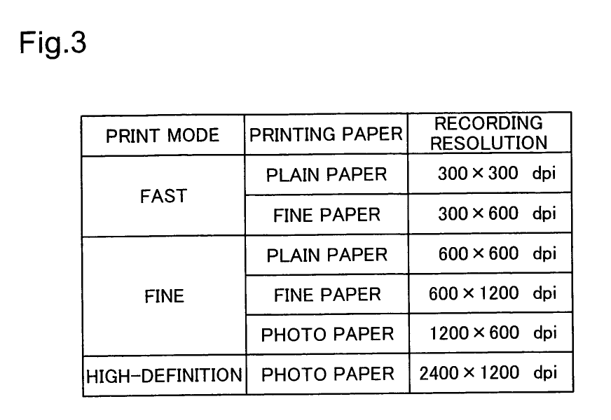

The printer 10 of this embodiment has six different recording resolutions as available options as shown in FIG. 3, that is, 300×300, 300×600, 600×600, 600×1200, 1200×600, and 2400×1200 dpi. One of the six recording resolutions is set corresponding to the user's selection of the print mode and the printing paper. The print mode setting module 12 of the embodiment is equivalent to the recording resolution setting module of the invention.

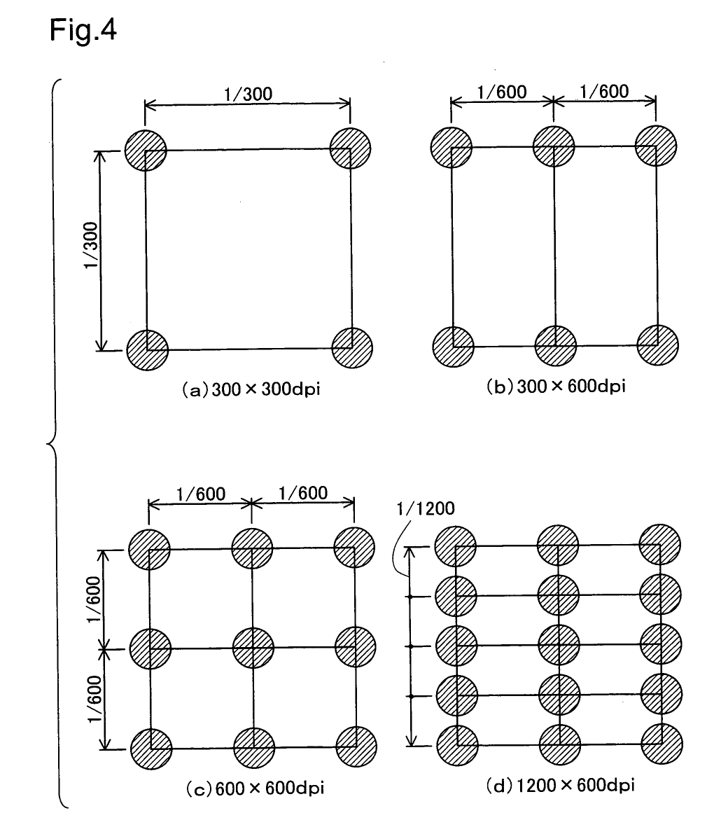

FIG. 4 conceptually shows creation of dots at various recording resolutions. FIG. 4(a) shows dot creation at the recording resolution of 300×300 dpi, FIG. 4(b) dot creation at the recording resolution of 300×600 dpi, FIG. 4(c) dot creation at the recording resolution of 600×600 dpi, and FIG. 4(d) dot creation at the recording resolution of 1200×600 dpi. At the recording resolutions of FIGS. 4(a) and 4(c), the dots are created at equal pitches in the vertical direction and in the horizontal direction. At the recording resolutions of FIGS. 4(b) and 4(d), on the other hand, the dots are created at unequal pitches in the vertical direction and in the horizontal direction. The dots created at the recording resolution of FIG. 4(b) are denser in the horizontal direction, whereas the dots created at the recording resolution of FIG. 4(d) are denser in the vertical direction.

The respective actuators included in the printer 10 are controlled to create dots at the set recording resolution. The recording resolution in the vertical direction (in the sub-scanning direction) is changed by adjusting the rotational angle of the paper feed motor 33. The recording resolution in the horizontal direction (in the main scanning direction) is changed by adjusting the repeated driving frequency applied to the piezoelectric elements. Each of the different recording resolutions is settable by such adjustment of the rotational angle and the repeated driving frequency under the condition of a fixed moving speed of the print head unit 25 in the main scanning direction, that is, under the condition of a fixed head speed.

With reference back to FIG. 2, after the user's selection of the desired image as the object of printing and the desired print mode and subsequent setting of the recording resolution corresponding to the user's selection, the printer driver 11 reads and inputs RGB color image data of the selected image from the memory card MC. The resolution conversion module 13 converts the resolution of the input RGB color image data into the recording resolution set by the print mode setting module 12. When the resolution of the input RGB color image data is lower than the set recording resolution, linear interpolation is performed to generate new data between existing adjacent image data. When the resolution of the input RGB color image data is higher than the set recording resolution, on the other hand, existing image data are skipped at a preset rate.

The RGB color image data having the converted recording resolution goes through color conversion by the color conversion module 14 to be converted into image data of the available colors in the printer 10. The color conversion process converts image data expressed by a combination of tone values of the three primary colors R, G, and B into image data (CMYK data) expressed by a combination of tone values of the respective colors C, M, Y, and K used in the printer 10. A typical procedure of the color conversion refers to a known three-dimensional color conversion table 15 (LUT) to attain quick color conversion. The resolution conversion and the color conversion by the resolution conversion module 13 and the color conversion module 14 generate multi-tone data expressed by 256 tones in a tone value range of 0 to 255 with regard to each of the C, M, Y, and K colors.

The CMYK data generated by the color conversion is then subjected to a halftoning process executed by the halftoning process module 17 to change the expressive number of tones. The halftoning process typically converts the CMYK data expressed by 256 tones into 2-tone data representing only the dot-on state and the dot-off state.

A first embodiment of the invention adopts a (systematic) dither method for the halftoning process as described below. The dither method compares the tone value of the CMYK data in each target pixel with a threshold value allocated to the position of the target pixel and specifies the target pixel as a dot-on pixel on condition that the tone value is greater than the threshold value and the target pixel as a dot-off pixel on condition that the tone value is smaller than the threshold value. In this manner, the CMYK data expressed by 256 tones are converted into dot state data representing the dot-on state or the dot-off state in each pixel. The dither method uses a matrix of multiple threshold values recorded corresponding to the respective pixel positions. This matrix is hereafter called a threshold value matrix.

For the halftoning process of the first embodiment, the halftoning process module 17 uses three different threshold value matrixes A, B, and C. The halftoning process is performed according to one threshold value matrix, which is selected corresponding to the aspect ratio of the set recording resolution among the three different threshold value matrixes A, B, and C. The halftoning process module 17 does not require six different threshold value matrixes corresponding to the six different recording resolutions but provides only three different threshold value matrixes corresponding to the three different aspect ratios. Namely the halftoning process of the first embodiment commonly uses each threshold value matrix for two different recording resolutions having an identical aspect ratio. The three threshold value matrixes A, B, and C are all distributed matrixes. The halftoning process will be described in detail below.

With reference to FIG. 2 again, the interlacing process module 20 rearranges the dot state data obtained as a result of the halftoning process by considering the order of actual dot creation and outputs the rearranged dot state data as print data. A concrete procedure rearranges the dot state data in the order of actual dot creation determined by the motions of the print head unit 25 and outputs the rearranged dot state data as print data. The control circuit 40 drives the respective actuators according to the resulting print data to create ink dots of the respective colors on the printing paper P and complete a resulting printed color image. The interlacing process module 20 of the embodiment is equivalent to the data output module of the invention.

B. Halftoning Process of First Embodiment (Dither Method)

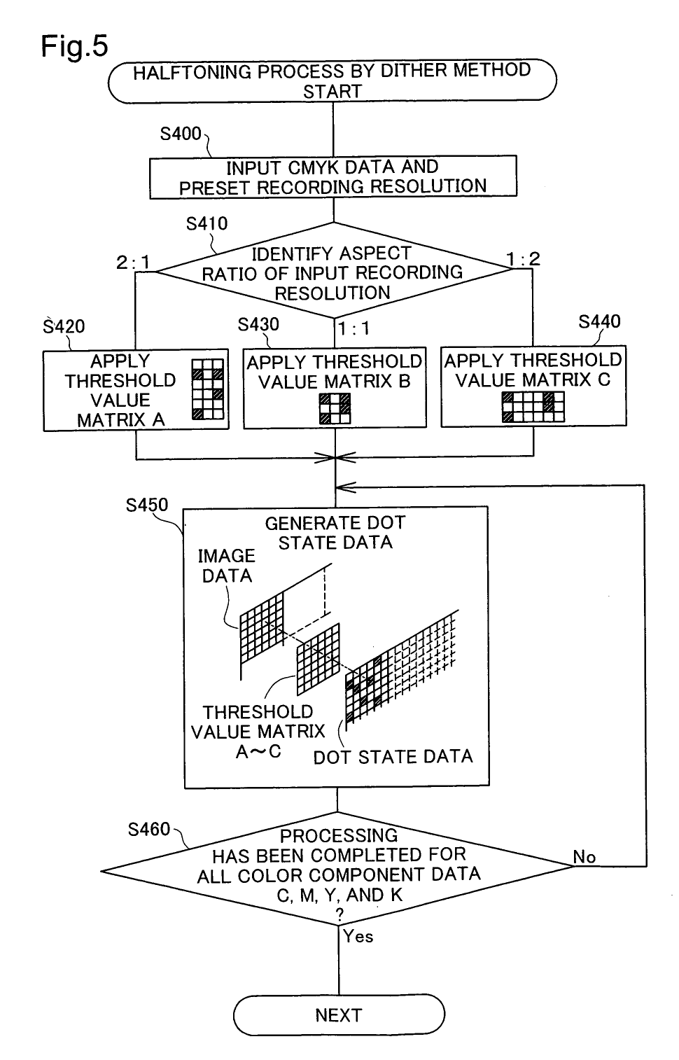

FIG. 5 is a flowchart showing the halftoning process of the first embodiment executed by the printer 10 constructed as described above. The CPU in the control circuit 40 of the printer 10 activates the printer driver 11 to perform the halftoning process of the first embodiment and convert the CMYK data into dot state data.

In the halftoning process of the first embodiment, the printer driver 11 first inputs color-converted CMYK data and a preset recording resolution (step S400) and identifies an aspect ratio of the input recording resolution (step S410). According to a concrete procedure, the printer driver 11 identifies an aspect ratio of 2 to 1 for either of the recording resolutions 1200×600 dpi and 2400×1200 dpi among the six available recording resolutions in the printer 10, an aspect ratio of 1 to 1 for either of the recording resolutions 300×300 dpi and 600×600 dpi, and an aspect ratio of 1 to 2 for either of the recording resolutions 300×600 dpi and 600×1200 dpi.

When the identified aspect ratio of the input recording resolution is 2 to 1 at step S410, the printer driver 11 selects the threshold value matrix A among the three threshold matrixes A, B, and C provided in advance (step S420). The threshold value matrix A is set corresponding to the recording resolution of 2400×1200 dpi. When the identified aspect ratio of the input recording resolution is 1 to 1 at step S410, the printer driver 11 selects the threshold value matrix B (step S430). The threshold value matrix B is set corresponding to the recording resolution of 600×600 dpi. When the identified aspect ratio of the input recording resolution is 1 to 2 at step S410, the printer driver 11 selects the threshold value matrix C (step S440). The threshold value matrix C is set corresponding to the recording resolution of 600×1200 dpi. Namely each of the threshold value matrixes is designed for the higher recording resolution between two different recording resolutions having an identical aspect ratio. Each threshold value matrix is used for the halftoning process at the lower recording resolution as well as for the halftoning process at the higher recording resolution having an identical aspect ratio.

The respective boxes of steps S420, S430, and S440 in FIG. 5 include conceptual views of dot state data generated by application of the threshold matrixes A, B, and C. The threshold value matrixes A, B, and C are designed to prevent consecutive creation of dots in adjacent pixels of each input image and ensure the appropriate dispersibility.

Dot state data representing the dot on-off state in respective pixels is then generated by application of the selected threshold matrix (step S450). The box of step S450 conceptually shows the process of generating dot state data by the dither method.

Image data shown in the box of step S450 is equivalent to one color component data of the input CMYK data generated for the respective colors C, M, Y, and K. Each rectangle of the image data represents one pixel. Tone values (not shown) expressed in the range of 256 tones are stored in the respective pixels of the image data, whereas threshold values (not shown) are stored in respective grids of the selected threshold value matrix. Application of the selected threshold value matrix onto the image data relates each pixel of the image data to one grid of the threshold value matrix and compares the tone value in each pixel with a threshold value stored in the corresponding grid.

Based on the results of the comparison, each pixel having the tone value greater than the corresponding threshold value is specified as a dot-on pixel, while each pixel having the tone value smaller than the corresponding threshold value is specified as a dot-off pixel. The hatched rectangles of the resulting dot state data represent the dot-on pixels.

Image data generally consists of a large number of pixels and is significantly greater in size than the threshold value matrix. One threshold value matrix is gradually shifted in position over the image data and is repeatedly used to determine the dot on-off state with regard to all the pixels of the image data. Such repeated application generates dot state data representing the dot on-off state determined for each of the pixels of the image data. The actual procedure specifies the dot on-off state not in the units of the applied threshold value matrix but in the units of rasters.

The printer driver 11 determines whether the processing for generating dot state data has been completed with regard to all the color component data C, M, Y, and K (step S460). When the processing has been completed for all the color component data (step S460: Yes), the processing flow terminates the halftoning process by the dither method and goes to the subsequent interlacing process. When the processing has not yet been completed for all the color component data (step S460: No), on the other hand, the processing flow goes back to step S450 to generate dot state data with regard to unprocessed color component data.

As described above, the halftoning process of the first embodiment requires only three threshold value matrixes for the six different recording resolutions available in the printer 10. Namely each threshold value matrix is commonly applied to two different recording resolutions having an identical aspect ratio. This arrangement desirably reduces the required memory capacity (ROM) for storing the threshold value matrixes. Each of the threshold value matrixes is designed corresponding to the higher recording resolution between two different recording resolutions having an identical aspect ratio. The threshold value matrix for the higher recording resolution is applied to the processing at the lower recording resolution as well as to the processing at the higher recording resolution.

C. Halftoning Process of Second Embodiment (Error Diffusion Method)

The halftoning process executed in a second embodiment of the invention adopts an error diffusion method, in place of the dither method of the first embodiment. The error diffusion method compares the sum of the tone value of the CMYK data in each target pixel and a total of distributed error divisions with a preset threshold value and specifies the target pixel as a dot-on pixel on condition that the sum is greater than the threshold value and the target pixel as a dot-off pixel on condition that the sum is smaller than the threshold value. This generates dot state data representing the dot on-off state with regard to all the pixels of the image data. An error of the tone value arises by specification of the dot-on state or the dot-off state in each target pixel. For example, specification of the dot-on state in a certain pixel may lower the tone of the pixel than the original tone value. In this case, the difference between the tone value of the dot created in the certain pixel and the original tone value of the certain pixel is given as an error. The error diffusion method distributes the error arising in the target pixel to unprocessed peripheral pixels with preset weighting factors. The total of such error divisions distributed from peripheral pixels with the respective weighting factors is to be added to the tone value of each target pixel. The error diffusion method uses error diffusion matrixes that specify weighting factors used for distribution of an error in each target pixel and the positions of peripheral pixels to receive error divisions distributed from the target pixel with the respective weighting factors.

The halftoning process of the second embodiment by the error diffusion method is executed by the printer 10 having the configuration described above with some modifications that a halftoning process module 170 replaces the halftoning process module 17 and that a printer driver 110 including the halftoning processing module 170 replaces the printer driver 11.

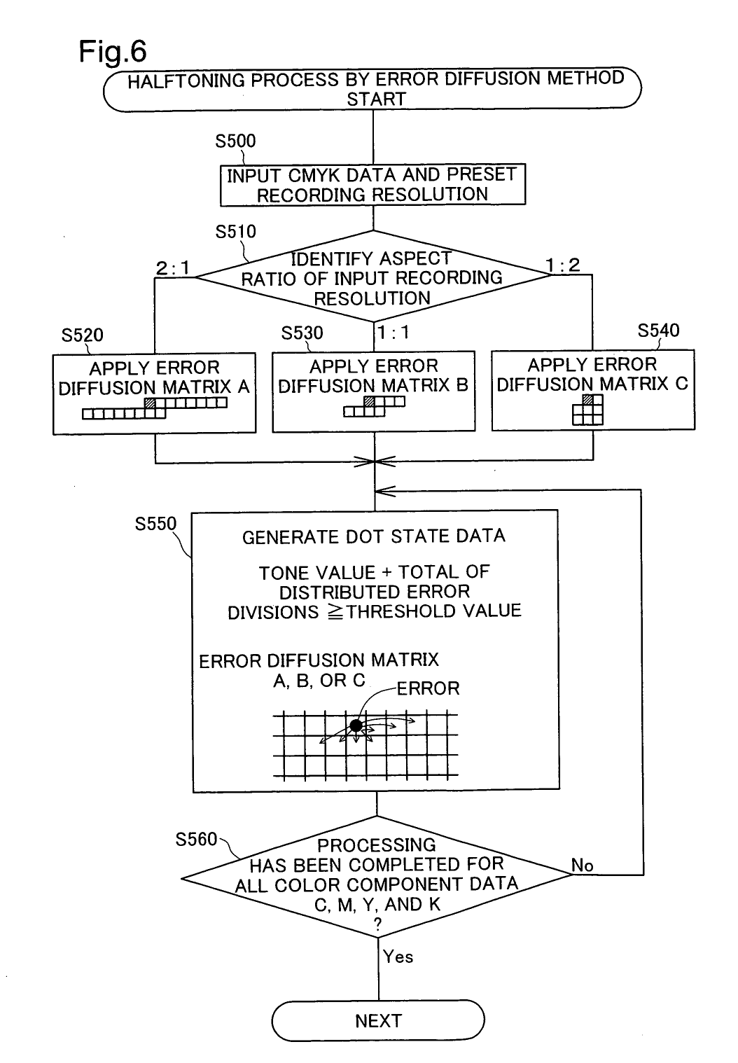

FIG. 6 is a flowchart showing the halftoning process of the second embodiment. The CPU in the control circuit 40 of the printer 10 activates the printer driver 110 to perform the halftoning process and convert the CMYK data into dot state data.

In the halftoning process of the second embodiment, the printer driver 110 first inputs color-converted CMYK data and a preset recording resolution (step S500) and identifies an aspect ratio of the input recording resolution (step S510). This identification step is identical with the corresponding step of the first embodiment and identifies the aspect ratio of the input recording resolution as 2 to 1, 1 to 1, or 1 to 2.

When the identified aspect ratio of the input recording resolution is 2 to 1 at step S510, the printer driver 110 selects an error diffusion matrix A among three error diffusion matrixes A, B, and C provided in advance (step S520). When the identified aspect ratio of the input recording resolution is 1 to 1 at step S510, the printer driver 110 selects the error diffusion matrix B (step S530). When the identified aspect ratio of the input recording resolution is 1 to 2 at step S510, the printer driver 110 selects the error diffusion matrix C (step S540). Each of the error diffusion matrixes is designed for the higher recording resolution between two different recording resolutions having an identical aspect ratio.

The respective boxes of steps S520, S530, and S540 in FIG. 6 include conceptual views of the error diffusion matrixes A, B, and C. Each rectangle denotes one pixel, and a hatched rectangle represents a target pixel as an object to be processed. The respective rectangles store predetermined rates (not shown) for distributing an error arising in the target pixel to unprocessed peripheral pixels. The error diffusion matrix A is extended in the main scanning direction relative to the error diffusion matrix B. Namely the error diffusion matrix A distributes the error arising in the target pixel to even relatively farther pixels in the main scanning direction. The error diffusion matrix C is extended in the sub-scanning direction relative to the error diffusion matrix B. Namely the error diffusion matrix C distributes the error arising in the target pixel to even relatively farther pixels in the sub-scanning direction. The error diffusion matrixes A, B, and C are designed to ensure the appropriate dispersibility in dot formation of each input image and give the highest printing quality.

Dot state data representing the dot on-off state in respective pixels is then generated according to the selected error diffusion matrix (step S550). The box of step S550 conceptually shows the process of generating dot state data by the error diffusion method.

Image data shown in the box of step S550 is equivalent to one color component data of the input CMYK data generated for the respective colors C, M, Y, and K. Each rectangle of the image data represents one pixel. Tone values (not shown) expressed in the range of 256 tones are stored in the respective pixels of the image data. The error diffusion method sequentially shifts a target pixel of processing in the main scanning direction of image data (that is, from the left end to the right end of the image) and compares the sum of the tone value in the target pixel and the total of the distributed error divisions with a preset threshold value to determine the dot on-off state in the target pixel. The distributed error divisions to be added to the tone value in the target pixel are stored in a memory area called an error buffer (not shown). An error arising in each target pixel is distributed to unprocessed peripheral pixels with weighting factors according to the selected error diffusion matrix. The error divisions distributed to one pixel are kept in the error buffer until the pixel is specified as a target pixel of processing. The error diffusion method generates dot state data with distribution of an error arising in each pixel to peripheral pixels, thus reducing the overall error of the whole image.

The printer driver 110 determines whether the processing for generating dot state data has been completed with regard to all the color component data C, M, Y, and K (step S560). When the processing has been completed for all the color component data (step S560: Yes), the processing flow terminates the halftoning process by the error diffusion method and goes to the subsequent interlacing process. When the processing has not yet been completed for all the color component data (step S560: No), on the other hand, the processing flow goes back to step S550 to generate dot state data with regard to unprocessed color component data.

As described above, the halftoning process of the second embodiment requires only three error diffusion matrixes for the six different recording resolutions available in the printer 10. Like the first embodiment, this arrangement desirably reduces the required memory capacity for storing the error diffusion matrixes.

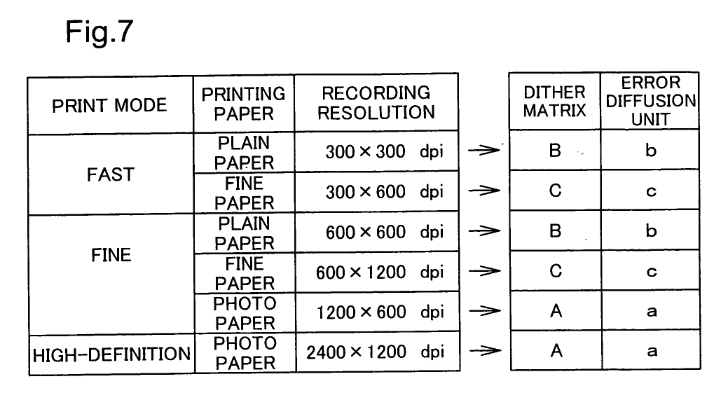

The printer may be designed to selectively perform the halftoning process of the first embodiment by the dither method or the halftoning process of the second embodiment by the error diffusion method. The printer of this design stores in advance both threshold value matrixes and error diffusion matrixes corresponding to available recording resolutions. The printer of this design allows the user to select the desired method of the halftoning process simultaneously with selection of the desired print mode and the desired printing paper among the possible options. The printer sets an appropriate matrix for the halftoning process corresponding to the user's selections as shown in FIG. 7. For example, the threshold value matrix B is selected in response to the user's selections of ‘fast’, ‘plain paper’, and ‘dither method’. In another example, an error diffusion unit ‘b’ including the error diffusion matrix B and other related settings is selected in response to the user's selection of ‘fast’, ‘plain paper’, and ‘error diffusion method’. This technique desirably reduces the required memory capacity for recording various settings of the halftoning process. The actual halftoning process by the error diffusion method changes over the applied error diffusion matrix according to the tone values of image data in the respective pixels and adopts a different processing flow for end pixels in the main scanning direction. The details of this processing are, however, not characteristic of the invention and are omitted from the explanation of the second embodiment for the easy and better understanding. Error diffusion units ‘a’, ‘b’, and ‘c’ respectively include required settings for the halftoning process in addition to the error diffusion matrixes A, B, and C.

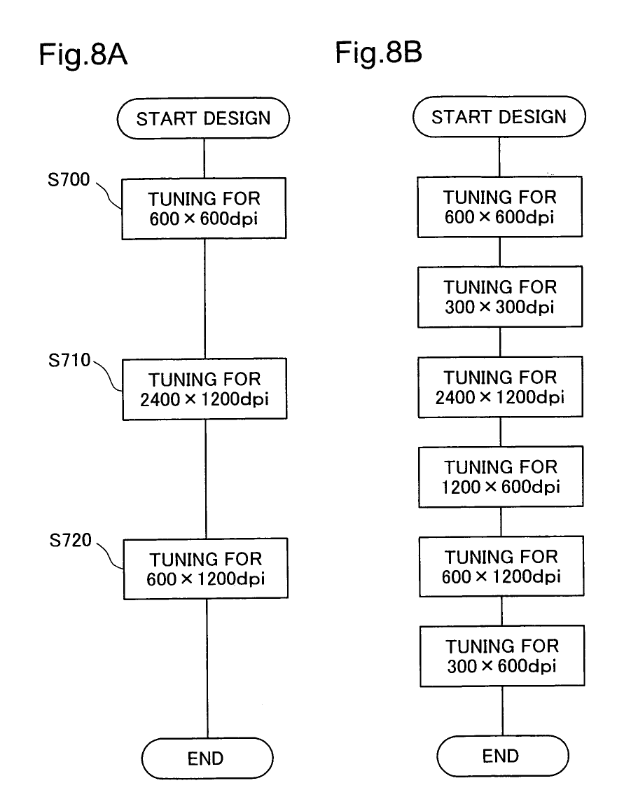

The halftoning process of the first embodiment and the halftoning process of the second embodiment are designed according to a design flow of FIG. 8A. The design flow first tunes the threshold value matrix B or the error diffusion matrix B for the recording resolution of 600×600 dpi (having the aspect ratio of 1 to 1) (step S700). The design flow then tunes the threshold value matrix A or the error diffusion matrix A for the recording resolution of 2400×1200 dpi (having the aspect ratio of 2 to 1) (step S710). The design flow subsequently tunes the threshold value matrix C or the error diffusion matrix C for the recording resolution of 600×1200 dpi (having the aspect ratio of 1 to 2) (step S720). This completes the design and tuning of the halftoning process module 17 or 170.

The tuning of each threshold value matrix arranges threshold values in the matrix to give the maximum dispersibility of dots, evaluates the arrangement of the threshold values according to a predetermined test sample, and eventually determines the arrangement of the threshold values. The tuning of each error diffusion matrix specifies the shape of the error diffusion matrix and the error diffusion rates according to a desired range of pixels receiving distributed error divisions, evaluates the specification according to a predetermined test sample, and eventually determines the specification. The actual tuning process is more complicated since the applied error diffusion matrix is changed over according to the tone values of image data in the respective pixels and the halftoning process is performed for multiple different dot diameters (for example, large-size dot, medium-size dot, and small-size dot).

For the purpose of comparison, FIG. 8B shows a conventional design flow of the halftoning process. This conventional design flow requires tuning of six different matrixes corresponding to six different recording resolutions available in a printer. The halftoning process of the first embodiment or the second embodiment classifies the recording resolutions by the aspect ratio and commonly uses an identical threshold value matrix or an identical error diffusion matrix for the multiple recording resolutions of an identical aspect ratio. This significantly reduces the total number of process steps in the design flow, compared with the conventional design flow. The technique of the invention thus reduces the development cost, as well as the required memory capacity for storing the matrixes used for the halftoning process.

D. Modifications

In the halftoning process of the first embodiment by the dither method, each threshold value matrix is shared by two different recording resolutions having an identical aspect ratio. Similarly in the halftoning process of the second embodiment by the error diffusion method, each error diffusion matrix is shared by two different recording resolutions having an identical aspect ratio. One possible modification may enable each halftoning process (that is, each halftoning process module) to be shared by recording resolutions having an identical aspect ratio. For example, a variable dot printer that is capable of creating large-size dots, medium-size dots, and small-size dots may adopt the dither method for the halftoning process of the large-size dots but the error diffusion method for the halftoning process of the medium-size dots and the small-size dots. In this case, the printer has multiple halftoning process modules corresponding to multiple aspect ratios (for example, three halftoning process modules corresponding to three aspect ratios). An appropriate halftoning process module is selected corresponding to the identified aspect ratio of a preset recording resolution.

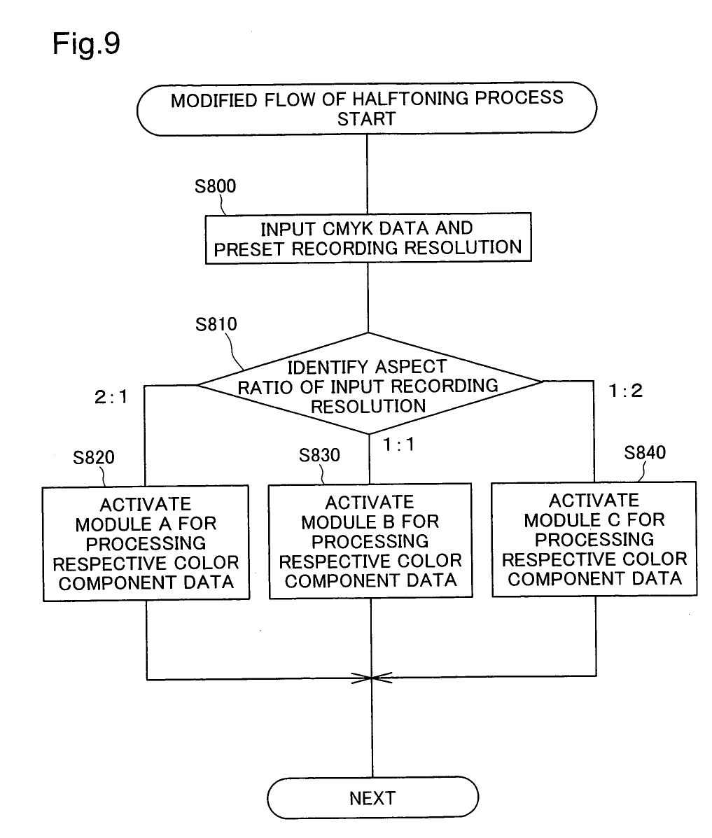

The flowchart of FIG. 9 shows a modified flow of the halftoning process. Like the halftoning processes of the first embodiment and the second embodiment, the modified flow of the halftoning process first inputs color-converted CMYK data and a preset recording resolution (step S800) and identifies an aspect ratio of the input recording resolution (step S810). When the identified aspect ratio is 2 to 1 at step S810, the modified flow activates a module A to generate dot state data of respective color components (step S820). When the identified aspect ratio is 1 to 1 at step S810, the modified flow activates a module B to generate dot state data of respective color components (step S830). When the identified aspect ratio is 1 to 2 at step S810, the modified flow activates a module C to generate dot state data of respective color components (step S840). This modified structure of selectively using the halftoning process module corresponding to the aspect ratio has the similar effects to those of the first embodiment and the second embodiment described above.

The technique of the invention is especially effective for a printer that executes the halftoning process by its hardware configuration. For example, a standalone printer having printer driver functions may have the hardware configuration to execute the halftoning process. The series of halftoning process by the error diffusion method is constructed by a logic circuit including AND, OR, and INV gates in this printer to input a tone value in each target pixel and distributed error divisions to the target pixel in response to a predetermined clock, sum up the tone value and the distributed error divisions, compare the sum with a preset threshold value, and write the result of the comparison into a memory. Application of the technique of the invention does not require the group of gates for each recording resolution in the printer of this hardware configuration. This desirably reduces the number of required parts and thus decreases the total manufacturing cost.

The technique of sharing a required element for the halftoning process corresponding to each aspect ratio is not restricted to the dither method or the error diffusion method but is also applicable to other methods of the halftoning process, for example, a density pattern method (halftone dot processing). The density pattern method applies one of multiple dot patterns having different white-black area ratios to express the halftone of each pixel. Application of the technique of the invention requires multiple dot patterns corresponding to multiple different aspect ratios of recording resolutions. The halftoning process thus commonly uses one dot pattern for multiple recording resolutions having an identical aspect ratio. This arrangement desirably reduces the required memory capacity for storing the dot patterns.

The embodiments and their applications and modifications discussed above are to be considered in all aspects as illustrative and not restrictive. There may be many other modifications, changes, and alterations without departing from the scope or spirit of the main characteristics of the present invention. For example, the technique of the invention is applicable to a minimized average error method, which is logically equivalent to the error diffusion method. The minimized average error method records an error arising in each pixel by determination of the dot-on state or the dot-off state in the pixel, into an error buffer. The minimized average error method multiplies recorded errors of peripheral pixels in the neighborhood of a target pixel by preset weighting factors, sums up the products of the errors and the weighting factors as an error sum, adds the error sum to the tone value of the target pixel, and determines the dot on-off state of the target pixel based on the result of the addition. This minimized average error method requires a set of weighting factors like the error diffusion method. Storage of a set of weighting factors corresponding to each aspect ratio effectively reduces the required memory capacity.

1. An image processing device that converts a resolution of input image data into a preset recording resolution, said image processing device comprising:
multiple halftoning process modules that are provided corresponding to multiple different aspect ratios of recording resolutions as resolutions for image recording and respectively perform different halftoning processes according to the different aspect ratios;
a recording resolution setting module that sets one recording resolution among multiple recording resolutions, which include at least two different recording resolutions having an identical aspect ratio;
a multi-tone data generation module that converts the resolution of the input image data according to the set recording resolution and generates multi-tone data representing tone values expressed in respective pixels of the image data:
a processing execution module that selectively activates one of the multiple halftoning process modules corresponding to an identified aspect ratio of the set recording resolution to perform the corresponding halftoning process and convert the multi-tone data into dot state data; and
a data output module that outputs the dot state data in a predetermined order as print data.

2. An image processing device in accordance with claim 1, wherein at least one of the multiple halftoning process modules has a threshold value matrix, which defines plural threshold values used for determination of a dot on-off state in each pixel, and adopts a dither method with the threshold value matrix for the halftoning process.

3. An image processing device in accordance with claim 1, wherein at least one of the multiple halftoning process modules has an error diffusion matrix, which defines error diffusion rates to distribute a density error arising in each pixel by determination of a dot on-off state in the pixel to peripheral pixels in a neighborhood of the pixel, and adopts an error diffusion method with the error diffusion matrix for the halftoning process.

4. An image processing device in accordance with claim 1, wherein at least one of the multiple halftoning process modules has multiple dot patterns for dot creation and selectively uses one of the multiple dot patterns for the halftoning process according to a density of each pixel in the image data.

5. An image processing device in accordance with claim 1, wherein the recording resolution set by said recording resolution setting module has an aspect ratio out of three aspect ratios of 2 to 1, 1 to 1, and 1 to 2 and is selectable between the at least two different recording resolutions having an identical aspect ratio.

6. An image processing method that converts a resolution of input image data into a preset recording resolution, said image processing method comprising:
providing multiple halftoning process modules corresponding to multiple different aspect ratios of recording resolutions as resolutions for image recording to respectively perform different halftoning processes according to the different aspect ratios;
setting one recording resolution among multiple recording resolutions, which include at least two different recording resolutions having an identical aspect ratio;
converting the resolution of the input image data according to the set
recording resolution and generating multi-tone data representing tone values expressed in respective pixels of the image data;
selectively activating one of the multiple halftoning process modules corresponding to an identified aspect ratio of the set recording resolution to perform the corresponding halftoning process and convert the multi-tone data into dot state data; and
outputting the dot state data in a predetermined order as print data.

7. A program product that causes a computer to execute a series of image processing that converts a resolution of input image data into a preset recording resolution, said program product comprise a recording medium and program code recorded on the medium, wherein the program code includes:
a first program code of setting one recording resolution among multiple recording resolutions, which include at least two different recording resolutions having an identical aspect ratio;
a second program code of converting the resolution of the input image data according to the set recording resolution and generating multi-tone data representing tone values expressed in respective pixels of the image data;
a third program code of selectively activating one of multiple halftoning process modules corresponding to an identified aspect ratio of the set recording resolution to perform the corresponding halftoning process and convert the multi-tone data into dot state data, where the multiple halftoning process modules are provided corresponding to multiple different aspect ratios of recording resolutions as resolutions for image recording and respectively perform different halftoning processes according to the different aspect ratios; and
a fourth program code of outputting the dot state data in a predetermined order as print data.

8. A recording medium that is included in a program product in accordance with claim 7,
said recording medium storing said first to fourth program codes in a computer readable manner.

9. An image processing device in accordance with claim 2, wherein the recording resolution set by said recording resolution setting module has an aspect ratio out of three aspect ratios of 2 to 1, 1 to 1, and 1 to 2 and is selectable between the at least two different recording resolutions having an identical aspect ratio.

10. An image processing device in accordance with claim 3, wherein the recording resolution set by said recording resolution setting module has an aspect ratio out of three aspect ratios of 2 to 1, 1 to 1, and 1 to 2 and is selectable between the at least two different recording resolutions having an identical aspect ratio.

11. An image processing device in accordance with claim 4, wherein the recording resolution set by said recording resolution setting module has an aspect ratio out of three aspect ratios of 2 to 1, 1 to 1, and 1 to 2 and is selectable between the at least two different recording resolutions having an identical aspect ratio.
